(19) United States
(12) Patent Application Publication
(10) Pub. No.: US 2009/0240616 A1
(43) Pub. Date: Sep. 24, 2009

(54) Establishing an Inventory Management and Trading Application for Alternative, Liquid Repurchase Agreement Markets

(75) Inventors: Kyle E. Hammer, Syosset, NY (US); Peter P. Gioia, Staten Island, NY (US); George A. Copin, London (GB)

Correspondence Address: DICKSTEIN SHAPIRO LLP, 1633 Broadway, NEW YORK, NY, 10019, US

(73) Assignee: ICAP SERVICES NORTH AMERICA LLC

(21) Appl. No.: 12/435,752

(22) Filed: May 5, 2009

Related U.S. Application Data
(62) Division of application No. 11/371,696, filed on Mar. 8, 2006.
Application No. 11/371,696 is a continuation of application No. 11/062,188, filed on Feb. 17, 2005, now abandoned.

(51) Int. Cl. G06Q 40/00

(52) U.S. Cl. 705/37

(57) ABSTRACT

The invention relates to a system and method for repo trading. The invention facilitates the inventory collection, organization, and search of the long and short positions of financial instruments such as corporate bonds and equities through the provision of a database. The invention also provides users with the ability to match borrowers and lenders with opposing positions for financial instruments. In a second embodiment the invention provides a system for creating pseudo-securities, from a diverse population of corporate bonds or equities that meet parameters specified by a user.

### CROSS REFERENCE TO RELATED APPLICATION

This application is a continuation of application Ser. No. 11/062,188, filed on Feb. 17, 2005, which is hereby incorporated by reference in its entirety.

### FIELD OF THE INVENTION

The present invention relates generally to electronic trading systems, and particularly to a database in combination with a trading system and corresponding methods that allow dealers and brokers to facilitate the inventory, collection, organization, storage and subsequent search of the long and short positions of financial instruments such as corporate bonds and equities, and the ability to match borrowers and lenders of these securities.

### BACKGROUND OF THE INVENTION

### The Corporate Bond Repurchase Agreement Markets

A repurchase agreement (repo) is an agreement between a seller and a buyer whereby the seller agrees to sell the buyer a security at a specified price with a commitment to buy the security back at a later date for another specified price. The majority of repos are overnight transactions, with the sale taking place one day and being reversed the next day. Long-term repos, called term repos, are less common and can extend for one month or more. Usually, repos are for a fixed period of time, but open-ended repos may also be negotiated. In a repo transaction, the party who sells and later repurchases a security is said to perform a repo. The term reverse repo is used to describe the opposite side of a repo transaction, i.e., the buyer who purchases and later resells the security is said to have performed a reverse repo.

While legally a repo is the sale and subsequent repurchase of a security, its economic effect is that of a secured loan. From an economic viewpoint, the party purchasing the security makes funds available (a loan) to the seller and holds the security as collateral. If the repoed security pays a dividend, coupon or partial redemption during the term of the repo, this payment is returned to the original owner. The difference between the sale price and the repurchase price for the security represents the interest on the loan. Indeed, repos are quoted as interest rates. Repos are attractive to many investors because the interest rates are negotiated by the parties and are generally lower than loan rates obtainable from banks.

Repos are used by a variety of investors and institutions for different reasons. There are generally two motives for entering into a reverse repo: (i) use of the repo as short-term investment of funds, or (ii) to obtain temporary use of a particular security. For example, securities dealers use repos to finance their securities inventories. They repo their inventories—rolling the repos from one day to the next. Counter-parties to these repos are often institutions, such as money market funds, which have short-term funds to invest, or they may be parties who wish to briefly obtain use of a particular security. For example, a party may require a particular security because they wish to sell the security short, or they may need to deliver the security to settle a trade with another party.

One way in which dealers attract customers is to invest capital in fixed income securities so as to provide liquidity within the marketplace for their customer's trades. Dealers also frequently provide research services to their clients related to such securities. Dealers often put their own capital at risk when buying and selling from clients by either (i) buying the securities first and warehousing them as inventory or (ii) buying the securities and opening a new position in the market. Each of these approaches requires dealers to use their own capital in order to provide liquidity to their clients. Dealers are in this manner considered market makers for their clients. While dealers prefer to buy and sell to their own clients, i.e., buying from one client to sell to another, if other clients are not prepared to trade, and the dealer is not willing to risk further capital, then the dealer is forced to use the open market to trade the client's securities.

The market practice of dealers trading their client's securities on the open market has been in place for many years for repos on bonds that have large issuance and consistent credit ratings such as U.S. Treasuries and Foreign government bonds and U.S. Agencies. The market for U.S. bonds is further standardized as most U.S. government and municipal bonds are assigned a CUSIP number, a nine character identification number assigned to most securities.¹ CUSIP stands for Committee on Uniform Securities Identification Procedures. In addition to U.S. and municipal bonds, CUSIP numbers are also assigned to most securities, including stocks of all registered U.S. and Canadian companies (a similar system, the CUSIP International Numbering System is used for foreign securities). CUSIP numbers play a key role in the accurate and efficient clearance and settlement of securities and other financial instruments as well as back-office processing. ¹ The CUSIP system is owned by the American Bankers Association and is operated by Standard & Poor's.

The U.S. Treasury bond repo market is very liquid and trades on several electronic systems. This is because there are several hundred large issue bonds, all issued by a single, highly rated issuer—the U.S. Treasury. Recently, there has been a growing demand for a market for repo of other types of financial instruments, including U.S. corporate bonds, Eurobonds and equities. However, as noted above, in the corporate bond and equity markets there are thousands of corporate issues with thousands of different issuers. These securities introduce inconsistent credit ratings and consist of a large and diverse issue base of small amounts. For example, there are over six thousand listed equities in the U.S. and thousands of unique corporate bond issues. Currently, there is no electronic trading system designed to handle the problems that would be introduced into the systems' repo market by the addition of such a large and diverse selection of corporate bonds and equities. Instead, the market depends on intermediary brokers to use their own inventory to trade.

### How the Repo Market Functions

The repo market for corporate bonds is relatively new, and trades in an over-the-counter (OTC) voice-brokered model. Presently there is no completely electronic service available for the corporate bonds and equities repo market. In the present model, via the telephone, customers provide the broker with a list of securities that the customers own or are “long,” and/or a list of securities that they wish to borrow, or are “short.” Brokers then manually compare these lists across numerous customers and look for pairings, or trade opportunities between customers, or based on their knowledge of typical customer interests, attempt to match the interest with the inventory. Once a broker identifies a lender of a particular security and a potential borrower for that security, the parties then identify the amount that will be borrowed or lent, and negotiate the price, or rate, at which the repo will take place. E-mail is often used to document the transaction. This process is typical of illiquid OTC trading and contains numerous inefficiencies; in particular it limits the market participants' ability to discover the best price for their borrowing or lending needs.

Due to the illiquid nature of corporate bond repos, the trades are not centrally cleared with industry utilities such as the Fixed Income Clearing Corporation, or FICC, which clears, nets, settles and manages the risk arising from a broad range of U.S. Government securities transactions. Any transaction between two parties which requires a settlement with no clearing house to guarantee settlement involves some credit risk to the parties and therefore it is normal to disclose the names of the parties before a trade can be completed. To provide some level of assurance and transparency in repo trading, the counter-party names are released at the time of trade since the securities are bi-laterally traded and each party to a repo transaction is relying on delivery of the securities.

### Current Electronic Trading Systems

Inter-dealer electronic broker systems play an important role in providing liquidity between the dealers while also facilitating full trading functionality. An example of an inter-dealer electronic trading system of repos is the exchange offered by BrokerTec. In BrokerTec's system, U.S. Treasury and European Government Bonds are listed for borrowing or lending with a two-sided bid-offer spread. BrokerTec provides its users with access to a deep pool of liquidity that includes major participants in both the U.S. and European fixed income marketplaces. This is made possible through the highly liquid nature of U.S. Treasuries and other sovereign debt, and is not available for corporate bonds.

Although repo trading in electronic systems for financial instruments has been described in the prior art, these systems do not fully address the changes necessary to fully facilitate repo trading of a diverse pool of corporate bonds and equities in an electronic system. One example of a repo trading system is described in U.S. patent application Ser. No. 10/444,092. The trading system described in this patent application provides a registration system for repo trades whereby the seller or the buyer in a repo transaction registers the collateral (any number of financial instruments) with the system. Registration allows for parties to a transaction to easily check the financial instrument's validity for use as collateral in a repo transaction. To register the financial instrument the system also queries the registering party as to the identity of the collateral using an interface function. The identity of the collateral is then sent from the interface to a second function within the system that operates to keep track of financial instruments that have been used for repo collateral in the system during a set time frame. While this system provides a registration process for repos to verify the validity of securities offered as collateral, it does not provide users with the means to search and match offers and bids and thus has limited utility to dealers and brokers in need of a system that maintains a searchable inventory of bids and offers for repo transactions.

Another example of a more specialized trading system is a municipal bond trading system. The municipal bond trading is similar to repo trading in some respects, but has several fundamental differences from repo trading. Municipal bonds are similar to U.S. Treasury and European Government Bonds as they are issued by U.S. municipalities rather than corporations (as the corporate bond and equity repos). As noted above, municipal bonds are assigned CUSIP numbers, which assist in ensuring the accurate and efficient clearance and settlement of these bonds. Municipal bonds are attractive to many investors because the interest income is exempt from federal income tax, and in some cases, state and local taxes as well. Municipal bond trading differs from repos in that they are securities that are bought and sold on the trading system, without a repurchase of the bonds by the seller. Once traded, the municipal bonds are retained by the buyer as most investors retain municipal bonds until they mature. There is also a much smaller pool of municipal bonds in which investors may trade than the pool of corporate bonds and equity repos. Because of these fundamental differences between municipal bond trading and repo trading, the requirements of an electronic trading system for the different trades are also different. The municipal bond trading system maintains an inventory of municipal bonds (divided by region) that users can search. However, as noted above, the municipal bonds are simply, bought and sold over the system without the repurchase side that is present in repo trading, thus the functionality provided by the municipal bond trading systems are inadequate to address the needs of repo trading.

### BRIEF SUMMARY OF THE INVENTION

The system and methods of the present invention enable dealers to electronically submit a listing of the inventory of their corporate bond and equity positions or longs (“bids wanted”) and borrowing requirements or shorts (“offers wanted”), into a database. Once the inventory and borrowing requirements are in the database, the brokers and/or dealers can search the database to find suitable matches. Transactions can then be completed from matches of interests either off-line with the help of a broker or electronically by the dealers themselves. Systems and methods are also provided for creating synthetic securities with their own pseudo-CUSIP identification number. The establishment of the pseudo-CUSIP identification number allows users of the system to create a general collateral from a group of securities that satisfy certain conditions defined by the user in the setup. These conditions may include ratings or types of securities. By enabling users to create this type of general collateral from a diverse population of corporate bonds or equities, the system allows for greater liquidity and a higher percentage of matches of bids and offers.

### BRIEF DESCRIPTION OF THE DRAWINGS

FIG. 1 is a graphical illustration of the repo trading system in accordance with a preferred embodiment of the present invention.

FIG. 2 is a graphical illustration of a repo transaction.

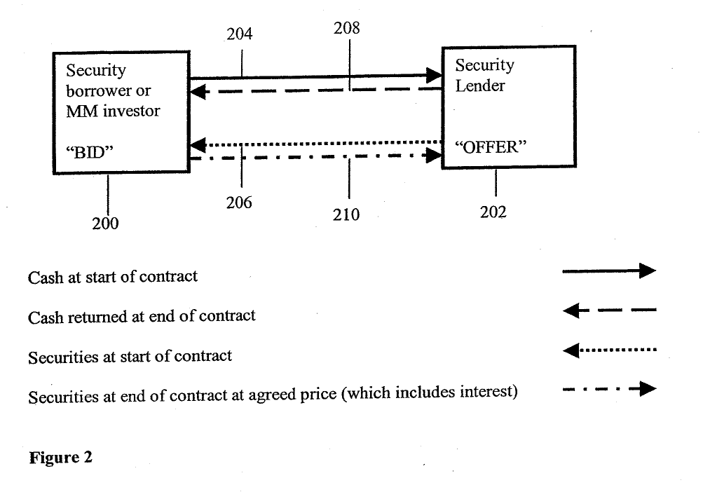

FIG. 3 shows the display of the inventory search results that is provided to users.

FIG. 4 is a block diagram illustrating the operation in accordance with an alternative embodiment of the present invention

FIG. 5 shows the display of the screen to create a general collateral repo that is provided to users.

FIG. 6 shows the display of the description of a general collateral repo that is provided to users.

### DETAILED DESCRIPTION OF THE INVENTION

In the current repo market for corporate bonds and equities, it is difficult for a buyer to find a match with a seller and vice versa. This difficulty can be attributed to the fact that dealers have many positions and requirements for funding and borrowing from a very diverse population of corporate bonds or equities. By creating a database of interests (bids and offers), and using human brokers to negotiate prices acceptable to both parties, the system facilitates completing suitable transactions in an efficient and timely manner. The system further facilitates the completion of suitable transactions by its use of pseudo-securities or general collateral that allows users, who are not concerned that they be matched for a specific security, to expand the range of securities that would match their needs by defining criteria for general types of securities that could meet their needs rather than specifying one particular security.

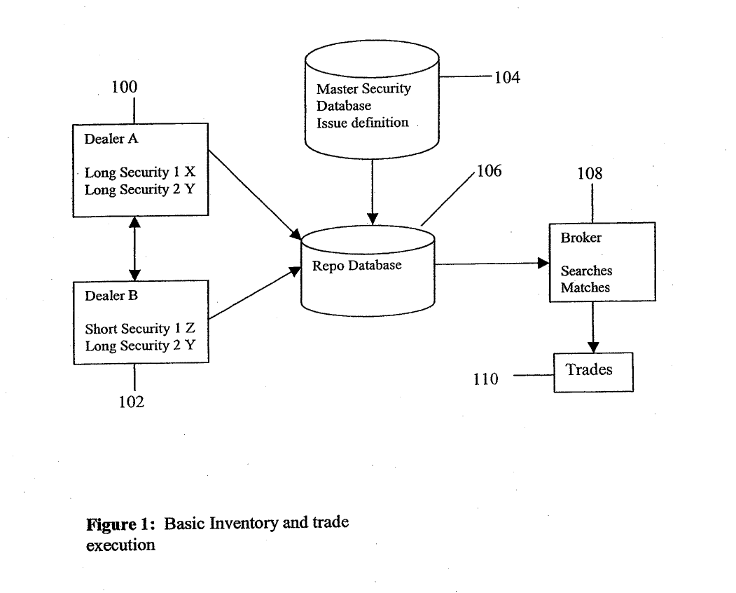

The invention will now be described with reference to the drawings. Dealers are able to submit their positions to the system as demonstrated in FIG. 1 by Dealer A 100 and Dealer B 102 electronically submitting listings of their corporate bond and/or equity positions (longs) and borrowing requirements (shorts), into the repo database 106. Once the positions and borrowing requirements are entered into the database 106, brokers 108 can search the database 106 to identify suitable matches.

The system allows users (brokers or dealers) to sort and search the inventory, using standard database search and sorting techniques, based on criteria defined by the user, e.g., interests, ratings, issuer, currency, size of bid wanted, size of offer wanted and term. The database may be searched across many dimensions, including corporate name, financial instrument description, contents or part of the description, CUSIP number, rating, rating range, bid wanted, offer wanted, rate, indicative rate, rates in a range, term, term ranges, and currency. Searches can be performed on a one-off basis, or titled and stored by the individual user for future use. In addition the time that the interest has been listed in the database is also important. The more recent listings are more likely to result in an on market rate and a trade. Therefore the search allows the user to sort by the time and date that an issue has been in listed in the system, examples are:
New Today
Last Hour
Last 30 Minutes
Last 15 minutes

Users are able to search the inventory through an interface provided on their terminals. A screen is provided to the users' terminals wherein the users can enter specific search criteria. In addition to the search criteria listed above, search criteria may also include the minimum and maximum amounts of the security required and the minimum and maximum security ratings the user will accept (including the option to specify a particular rating agency's rating or any other field the user specifies). The system includes an additional alert feature which provides users with updates regarding the inventory in the database. For example, when new inventory is entered into the system or a trade is executed, an alert appears on the user's display terminal and automatically opens a detail window.

If a suitable match is found, the parties who have been matched may enter into a trade 110. The system permits both brokers and dealers to search the database and execute a match. When the particular issue trades 110, if the entire amount is traded, the listing is no longer available. In the event that only a portion of the amount is traded, the balance is posted and remains available for trade.

The invention also makes use of industry standard securities master descriptive database 104, which uniquely identifies each issue, and combines this with the inventory details of position, long or short, amount in position, and if available, a price or rate that is available to trade.

If a trade is initiated, the borrower of the security 200 will send cash 204 to the lender of the security 202. The lender 202 in turn will provide the borrower 200 with the security required 206. At the end of the term of the repo, the lender 202 will receive the security back at an agreed upon price 210. In turn, at the end of the repo the lender 202 will provide the agreed upon buy back amount of cash 204 to the borrower 200.

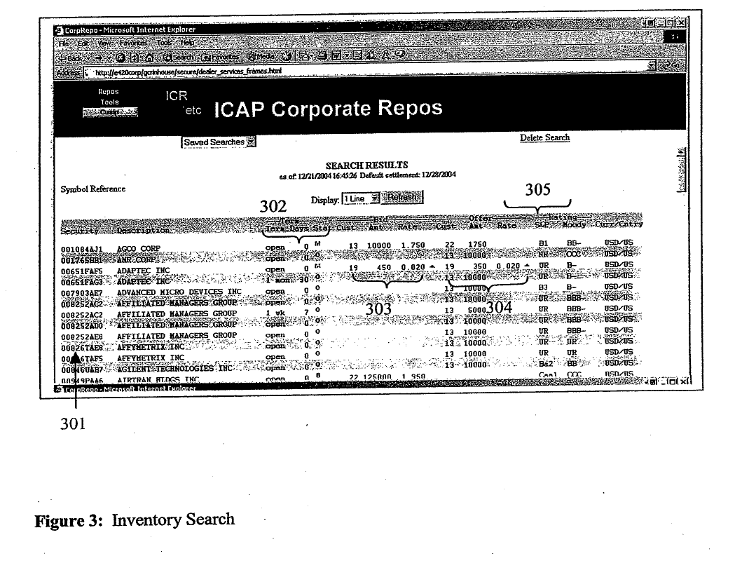

As shown in FIG. 3, the inventory available in the database is displayed on the user's terminal 300 via a web browser or other application at the user's terminal. The invention includes a messaging protocol that enables existing trading platforms' application to display the markets, prices and inventories available in the database. The invention displays the inventory with the securities' CUSIP numbers 301, a standard description of the inventory, and other relevant details as follows:

The term 302 is provided in the display and defines the length of the contract to borrow or lend the securities. The term 302 may be open, overnight (one day) or any other term requested by the user. “Open” means the term of the contract will continue in force at the agreed daily rate until one side demands that the contract comes to an end. The bid 303 is also provided in the display to users. The bid 303 is a request to borrow the security for the term in exchange for a payment expressed as a rate. The bid 303 also includes the customer number associated with it to allow the broker to identify the owner of the bid for settlement. The offer 304 is made by an owner of a security who is willing to lend the security for a specified time period in return for a payment. The offer 304 has a customer number associated with it to allow the broker to identify the owner of the offer for settlement. The rating 305 of the security is very important and affects the rate a borrower is willing to pay. Generally, the lower the rating is the higher the payment will be as the issue functions as collateral for the loan. The database is updated nightly in order to keep the ratings up to date. In the event of an intra-day rating change, the invention provides a screen for the broker to update the security rating detail in the master security database 104.

Once dealers have entered their interest, normally with no rate attached, into the database a trade can result by two methods:
1. The dealers monitor their own interests and if they find an offsetting position from another dealer they may complete the trade electronically, or
2. If there is a mismatch in demands a broker will discuss the options with the parties until they reach an agreement on price. Dealers may select either method based on their own trading preferences.

### General Collateral

While the previously disclosed embodiment of the invention provides a workable model for corporate bonds and equities repos, the simple matching of offsetting demands in a marketplace with thousands of issues is still a haphazard task. Because the matching of positions is not a one size fits all endeavor, additional functionality can be added to the basic repo trading system described above in order to facilitate the matching of positions for investors with different types of needs.

Investors with cash are relatively indifferent to the actual security received as collateral so long as it satisfies the investors rating requirements. For example all triple-A paper may be viewed by an investor as similar because the risk on all of the securities is essentially the same. Instead, the investor is concerned with the execution and timely investment of available funds. The alternative embodiment of the invention addresses the concerns of these types of investors by providing added functionality that allows users to create their own general class of securities that will meet their needs rather than specifying a specific security. Users, generally borrowers, can create a synthetic security that has its own dynamic pseudo-CUSIP number. As noted above, the CUSIP number is a nine-character number that identifies issuers and issues of financial instruments within a standard framework. CUSIP numbers are assigned by the CUSIP Service Bureau, however, in the system of the present invention, pseudo-CUSIP numbers are generated by the invention, using an algorithm that identifies them as a “security”, and assigns a next-in-line number that is always tied to the general collateral issue.

The pseudo-CUSIP numbers are generated as follows:

A pool of pseudo-CUSIP numbers beginning GCR000001 through GCR999999 are created in a database (with check digits attached—the check digit is generated using the “modulus 10” method, a simple algorithm used to verify numbers). As each number is used, it is removed from the pool. Once the pool has been depleted a new series is established, for example GCS000001 through GCS999999. These numbers are not reused and exist for the lifetime of the system.

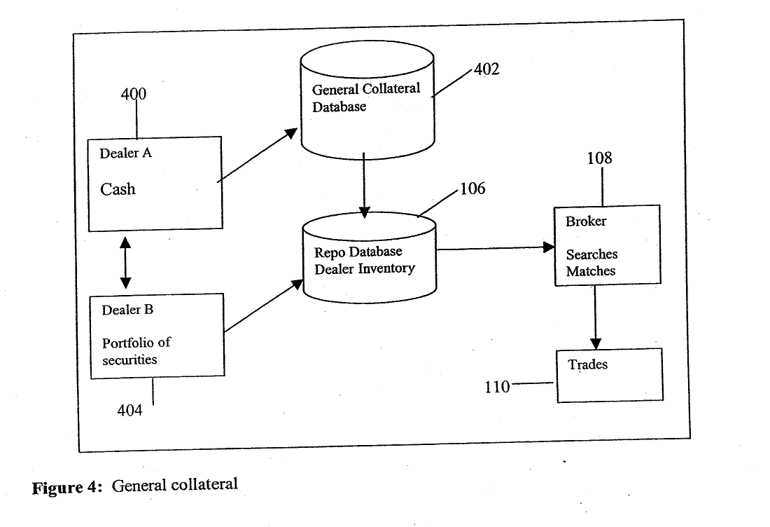

The synthetic security can encompass a group of securities that satisfy the conditions established by the user in the setup where the parameters for the synthetic security are defined. For example, an investor may define a security for one month and require that the security be at least Moody's Single-A or at least Standard & Poor's Triple-B. These pseudo-securities are referred to as “general collateral.” Because no such generalized security actually exists in the market place the system creates a pseudo-CUSIP referred to here as a Garban Uniform Securities Identification Number (“GUSIN”). The alternative embodiment of the invention will now be described with reference to FIG. 4.

In the General Collateral system, a first dealer with cash, Dealer A 400, wishes to establish a general collateral. Dealer A 400 defines the parameters of the general collateral and the general collateral is thereby entered into a general collateral database 402. For example, a dealer may define a general collateral as having a Moody's rating of AAA, with between five and fifty maximum pieces (the number of individual bonds, or pieces, that can make up a particular block of a trade) and allowing for substitutions to be made twice. A GUSIN number is created for the general collateral and the general collateral is then entered into the repo database 106. A second dealer, Dealer B 404, holds a portfolio of securities that matches Dealer A's 400 parameters for the general collateral. Dealer B 404 enters her inventory of securities she is willing to offer into the repo database 106. The master security database 104, which uniquely identifies each issue, and combines this information with the inventory details of position, long or short, amount in position, and if available, a price or rate that is available to trade, is also available in the system. The broker 108 is then able to search the database and match the offers and bids in the system. Searching is accomplished through an interface at the broker's 108 terminal using standard search and sorting techniques. The broker 106 is supplied a screen with a variety of fields (such as the type of ratings required, term of the repo, etc.) wherein she may enter the requirements for a matching position to a bid or offer. It is important to note that the dealers themselves are also able to search the database to determine if there is a match. Once a match has been found, the parties can then trade 110 the general collateral.

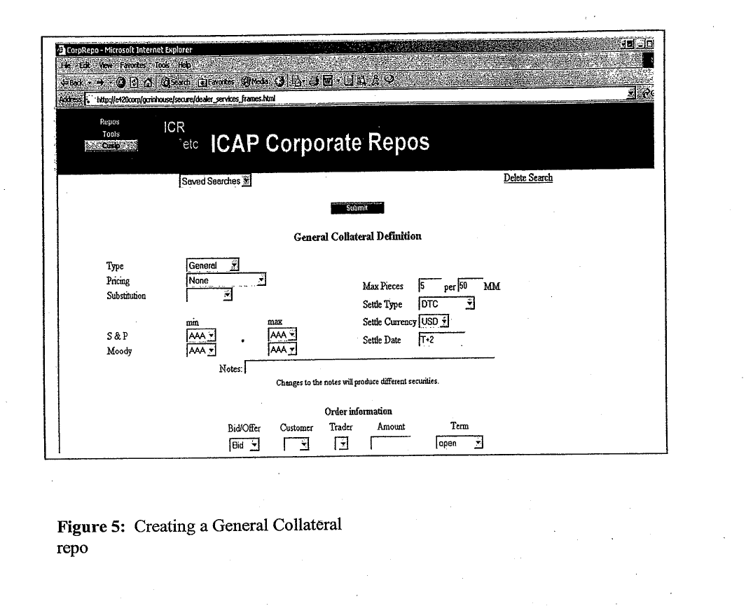

FIG. 5 provides an illustration of the screen provided to users to create general collateral issue and the terms that are used to define the issue. To investors, the most important of these definable fields are the term of the repo and the allowable ratings. The system allows a lower and upper band of ratings to be specified, although in practice only the lower limit is normally used. The lower limit is normally used rather than the upper because the rating reflects the underlying health of the entity issuing the debt. Typically, dealers are concerned with low ratings, not high. An investor will always be satisfied by securities with a higher rating and thus the rate applied will always reflect the lower band limit. The system allows these bands, although in practice they are not used a great deal other than to provide flexibility.

In the repo markets, general collateral trades are used to agree on a rate at which bonds will be borrowed and lent, and a broad group of securities would be available to fulfill the lending obligation. This is principally a cash flow trade collateralized with liquid bonds. In the case of corporate repos, the invention permits a user to define a series of parameters, including a variety of economic terms. While several different fields are provided, the user may define as many or as few fields as she sees fit. Once the fields are completed, the system allocates a unique GUSIN number (pseudo-CUSIP number). As described above, the system assigns the GUSIN number to a general collateral by using an algorithm. The fields available to define a general collateral are described below.

Type. Type refers to the type of securities allowed. Types include: (1) General: A general classification of any security in the database; (2) Convertible: A limitation to only select Convertible Bonds, which are bonds that can be converted into a predetermined amount of the company's equity at certain times during its life; and (3) ABS: A limitation to only select Asset Backed Securities, which are securities backed by notes or receivables against assets other than real estate.

Pricing. Pricing refers to which pricing method is to be used for the security. Pricing options include: (1) None: No specific limitations are set as to the price of the underlying security; (2) Garban Generic: Use the price that the Garban Repo reports assigns to the trade; and (3) Bloomberg Generic: Use only the Bloomberg collateral price. (Bloomberg reports a “Bloomberg Generic” price when it has five “live” prices to average for an issue. For some firms, this is an acceptable, independent pricing method)

Substitution. Substitution refers to whether the right of substitution of one security for another during the term of the contract is allowed. This is particularly important because a general collateral trade permits the lender to substitute securities during the term of the repo. Each substitution is referred to as a right of substitution. Substitutions may be allowed as follows: (1) Unlimited: The lender reserves the right to substitute securities at will; (2) None: Once securities have been lent, they cannot be substituted; (3) The specific number of times a security can be substituted (normally 1 to 5 times only); and (4) A pre-set number of times per time period, i.e. one substitution per month.

Rating. Another important aspect that must be defined is the rating agency to be used. Agencies that can be used include Standard & Poor's, Moody's Investor Services and comparable agencies. Traders can define a range of ratings that are acceptable in the pool of securities to select from to be considered for general collateral lending. The ratings are a reflection of the standards set by the ratings agencies, which can also include Fitch Ratings. Normally the upper limit will always default to AAA or the equivalent and the lower limit is the parameter which will drive pricing.

The user seeking to establish a general collateral trade also must define maximum pieces. When agreeing on a general collateral trade, each counter-party must know how large any particular delivery might be. The maximum pieces field permits the trader to define the number of individual bonds, or pieces, that can make up a particular block, or size, of a trade.

Settlement. Settle type is another preference that users can use. Settle type refers to where the borrower would prefer to settle the trade. Some of the choices available are:
Depository Trust Clearing Corporation (“DTC”);
Euroclear;
Fed Wire of the Federal Reserve Bank; and
Clear Stream.

Currency. The borrower or lender can define what currency will be accepted to settle the general collateral. Any number of currencies may be used for settlement purposes. Examples of some of the more popular currencies that may be used are the U.S. Dollar, Euro, British Pound, Japanese Yen, Canadian Dollar, Australian Dollar and Mexican Peso.

Settlement days. With respect to settlement, a settle date must also be provided. General collateral trades should be effective as of a specific date. The system of the present invention requires that the borrower or lender define The Trade Date, T, plus the number of days to pass before the trade settles. For example, T+2 is two days beyond the trade date.

Comments. A notes field is also provided to give the user an opportunity to specify terms that do not fit into the fields provided by the system. The “comment” field becomes part of the instrument description and is optionally searchable. This free text field permits the borrower or lender to define any specific requirements of a general collateral trade. For example, a trade could define “No piece less than 25 million,” or “Will not accept Company ABC for collateral.” This section applies to fields that a broker would create. As the invention is a hybrid model of brokers entering orders on their customers' behalf and traders entering orders on their own behalf, the broker needs to include account information.

Other fields provided include the bid/offer where the user may enter whether the order is a bid to borrow or an offer to lend, a customer field where a unique Customer ID for the company that the order is being placed on behalf of may be entered, a trader field to identify the particular trader that the order is being placed on behalf of, a field to enter the amount of the order and the term field where the user may specify the length of time in days, weeks or months that the general collateral trade will be effective for, i.e., the term of the loan.

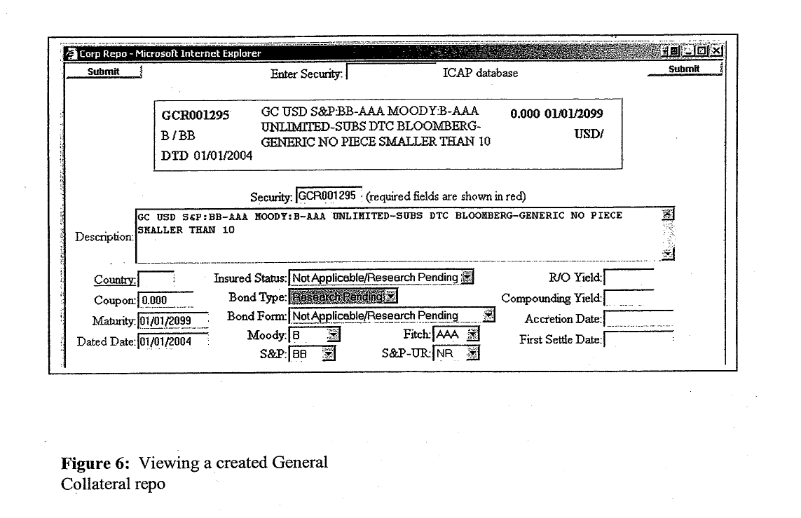

Once the general collateral issue is created, details of the issue are displayed within the inventory model as shown in FIG. 6. This method is substantially the same as the overall Corporate Repo inventory display browser.

While the present invention has been described in conjunction with specific embodiments, it is evident to those skilled in the art of the foregoing description that numerous additional alternatives, modifications and variations are possible. Accordingly, the present invention is not intended to be limited to only the described embodiments and should be interpreted to include all alternatives, modifications and variations.

1.-27. (canceled)

28. A method of creating a pseudo-security to facilitate trading of a financial instrument in a rep transaction, said system providing users the ability to define a pseudo-security which consists of one or more financial instruments that fit criteria specified by the users, said method comprising:
entering user defined criteria for a financial instrument or a plurality of financial instruments;
storing said user defined criteria in memory storage; and
creating a unique identifier for said financial instruments based on said user defined criteria.

29. The method of claim 28, wherein said unique identifier is a nine character number.

30. The method of claim 28, wherein said unique identifier for is stored in said memory.
